(19) United States
(12) Patent Application Publication
(10) Pub. No.: US 2026/0290729 A1
(43) Pub. Date: Sep. 24, 2026

(54) VACUUM VALVE AND VACUUM CIRCUIT BREAKER

(71) Applicant: Mitsubishi Electric Corporation, Chiyoda-ku, Tokyo (JP)

(72) Inventors: Nobuyuki SHINOHARA, Tokyo (JP); Toru KITAMURA, Tokyo (JP); Keiko YOSHIDA, Tokyo (JP); Takakazu HARADA, Tokyo (JP); Yuya EZAKI, Tokyo (JP); Shintaro YAMADA, Tokyo (JP); Nobuhiko KAJINAMI, Tokyo (JP)

(73) Assignee: Mitsubishi Electric Corporation, Chiyoda-ku, Tokyo (JP)

(21) Appl. No.: 18/881,097

(22) PCT Filed: Aug. 29, 2022
(86) PCT No.: PCT/JP2022/032356

§ 371 Date: Jan. 3, 2025

(51) Int. Cl. H01H 33/662

(52) U.S. Cl. CPC H01H 33/66238; H01H 2033/66246

(57) ABSTRACT

A vacuum valve includes: a cylindrical vacuum container that accommodates a movable-side electrode and a fixed-side electrode; a first flange and a second flange of a vacuum container; a drive rod that penetrates the first flange and moves the movable-side electrode to switch between a closing state and an interrupting state; a bellows flange fixed to a side surface of the drive rod; a bellows that has a concertina tube shape having a plurality of pleats, is bridged between the bellows flange and the first flange, and is extended and contracted when the driving rod switches between the closing state and the interrupting state; and a sliding member that is formed containing a non-porous material, is installed on at least one of an inner diameter side and an outer diameter side of the bellows, and is in contact with the plurality of pleats.

### FIELD

The present disclosure relates to a vacuum valve in which a movable-side electrode and a fixed-side electrode are accommodated in a vacuum container, and a vacuum circuit breaker including the vacuum valve.

### BACKGROUND

A vacuum valve in which a movable-side electrode and a fixed-side electrode are accommodated in a high-vacuum vacuum container cuts off a current by using high-vacuum insulation force and arc-extinguishing force. When the current is cut off, an arc is generated between the movable-side electrode and the fixed-side electrode. However, the vacuum valve extinguishes the arc by diffusing electrons, neutral particles, and ions constituting the arc, and prevents reignition by using high-vacuum insulation force.

The movable-side electrode moves in the vacuum container with linear sliding movement of a drive rod. A bellows is attached to the drive rod to maintain a degree of vacuum in the vacuum container. The bellows is extended and contracted during a closing operation in which the movable-side electrode and the fixed-side electrode are in contact with each other and during an interrupting operation in which the movable-side electrode and the fixed-side electrode are separated from each other. When the bellows is extended and contracted, vibration in an axial direction of the bellows is generated in pleats of the bellows, and stress is applied to the bellows.

In addition, the vacuum valve is required to cut off currents of a high voltage and a large current. However, in order to achieve the cut off, it is necessary to move the movable-side electrode faster during the closing operation and the interrupting operation than now. When movement of the movable-side electrode is made fast, the extension and contraction of the bellows attached to the drive rod also becomes fast, and vibration generated in the pleats of the bellows in the axial direction of the bellows becomes strong. For this reason, it has been difficult to downsize the bellows in order to secure vibration resistance.

Patent Literature 1 discloses a vacuum valve in which a guide tube containing a synthetic resin is put on an energizing rod of a movable contact, a metal ring is integrally formed at an intermediate position of a bellows, and the metal ring is slid on the guide tube to separately vibrate the bellows with the metal ring as a boundary, thereby preventing meandering of the bellows called buckling.

### CITATION LIST

### Patent Literature

Patent Literature 1: Japanese Unexamined Utility Model Application Publication No. H2-124630

### SUMMARY OF INVENTION

### Problem to be Solved by the Invention

However, the vacuum valve disclosed in Patent Literature 1 has been able to prevent buckling of the bellows, but has been unable to reduce vibration generated on the pleats of the bellows in the axial direction of the bellows.

The present disclosure has been made in view of the above, and an object of the present disclosure is to obtain a vacuum valve that reduces vibration generated in pleats in the axial direction of a bellows when the bellows is extended and contracted.

### Means to Solve the Problem

To solve the above problems and achieve an object, a vacuum valve according to the present disclosure includes: a first electrode; a second electrode; a vacuum container having a cylindrical shape and accommodating the first electrode and the second electrode, a first flange and a second flange to occlude both end portions of the vacuum container; a drive rod to move the first electrode fixed to one end portion of the drive rod in the vacuum container to switch between a closing state and an interrupting state, the drive rod penetrating the first flange and having the one end portion disposed in the vacuum container, the closing state being a state in which the first electrode and the second electrode are in contact with each other, the interrupting state being a state in which the first electrode and the second electrode are not in contact with each other, a bellows flange fixed to a side surface of the drive rod; a bellows to be extended and contracted when the drive rod switches between the closing state and the interrupting state, the bellows having a concertina tube shape with a plurality of pleats and being bridged between the bellows flange and the first flange; and a sliding member formed containing a non-porous material, installed on at least one of an inner diameter aide and an outer diameter side of the bellows, and being in contact with a plurality of the pleats.

### Effects of the Invention

According to the present disclosure, an effect is exhibited that it is possible to obtain a vacuum valve that reduces vibration generated in pleats in an axial direction of a bellows when the bellows is extended and contracted.

### BRIEF DESCRIPTION OF DRAWINGS

FIG. 1 is a schematic view illustrating a configuration of a vacuum circuit breaker according to a first embodiment.

FIG. 2 is a cross-sectional view of a vacuum valve according to the first embodiment.

FIG. 3 is a perspective view of a sliding member of the vacuum valve according to the first embodiment.

FIG. 4 is a cross-sectional view of a vacuum valve according to a second embodiment.

FIG. 5 is a cross-sectional view of a vacuum valve according to a third embodiment.

FIG. 6 is a cross-sectional view of a vacuum valve according to a fourth embodiment.

FIG. 7 is a cross-sectional view of a vacuum valve according to a fifth embodiment.

FIG. 8 is a cross-sectional view of a vacuum valve according to a modification of the fifth embodiment.

FIG. 9 is a cross-sectional view of a vacuum valve according to a sixth embodiment.

FIG. 10 is a cross-sectional view of a vacuum valve according to a first modification of the sixth embodiment.

FIG. 11 is a cross-sectional view of a vacuum valve according to a second modification of the sixth embodiment.

FIG. 12 is a cross-sectional view of a vacuum valve according to a third modification of the sixth embodiment.

FIG. 13 is a cross-sectional view of a vacuum valve according to a seventh embodiment.

FIG. 14 is a cross-sectional view of a vacuum valve according to a first modification of the seventh embodiment.

FIG. 15 is a cross-sectional view of a vacuum valve according to a second modification of the seventh embodiment.

FIG. 16 is a cross-sectional view of a vacuum valve according to a third modification of the seventh embodiment.

FIG. 17 is a cross-sectional view of a vacuum valve according to an eighth embodiment.

FIG. 18 is a perspective view illustrating a first modification of the sliding member of the vacuum valve according to the first to eighth embodiments.

FIG. 19 is a perspective view illustrating a second modification of the sliding member of the vacuum valve according to the first to eighth embodiments.

FIG. 20 is a perspective view illustrating a third modification of the sliding member of the vacuum valve according to the first to eighth embodiments.

FIG. 21 is a perspective view illustrating a fourth modification of the sliding member of the vacuum valve according to the first to eighth embodiments.

FIG. 22 is a perspective view illustrating a fifth modification of the sliding member of the vacuum valve according to the first to eighth embodiments.

FIG. 23 is a perspective view illustrating a sixth modification of the sliding member of the vacuum valve according to the first to eighth embodiments.

FIG. 24 is a side view illustrating a seventh modification of the sliding member of the vacuum valve according to the first to eighth embodiments.

### DESCRIPTION OF EMBODIMENTS

Hereinafter, a vacuum valve and a vacuum circuit breaker according to embodiments will be described in detail with reference to the drawings.

### First Embodiment

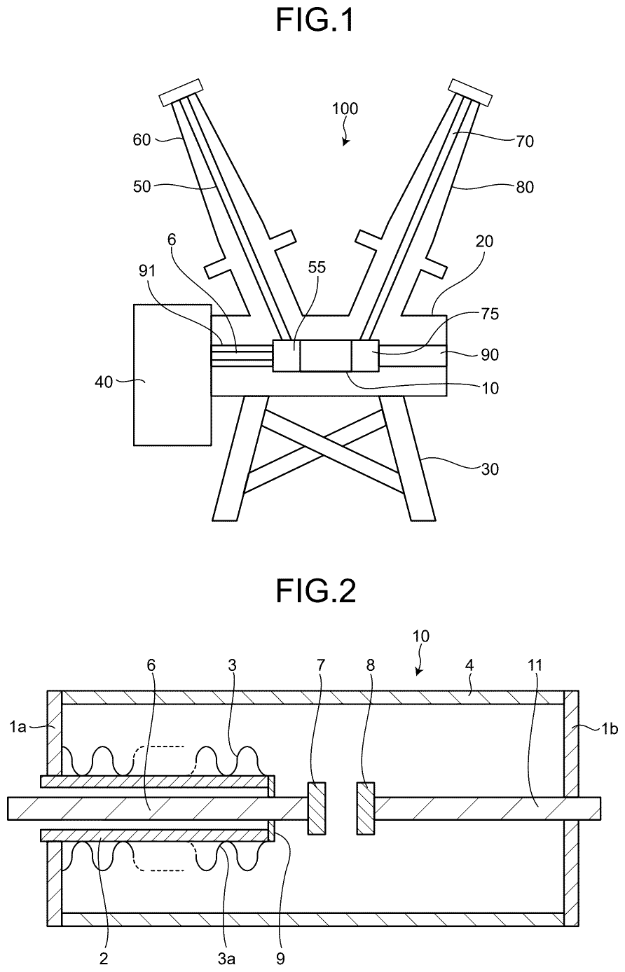

FIG. 1 is a schematic view illustrating a configuration of a vacuum circuit breaker according to a first embodiment. FIG. 2 is a cross-sectional view of a vacuum valve according to the first embodiment. A vacuum circuit breaker 100 includes: a vacuum valve 10 that accommodates a movable-side electrode 7 that is a first electrode and a fixed-side electrode 8 that is a second electrode in a vacuum container 4 and includes a drive rod 6 connected to the movable-side electrode 7, a tank 20 that accommodates the vacuum valve 10; a stand 30 that supports the tank 20; an operation device 40 that moves the movable-side electrode 7 in the vacuum container 4 by linearly moving the drive rod 6; a movable-side bushing 60 that accommodates a movable-side conductor 50; a movable-side frame 55 that electrically connects the movable-side conductor 50 and the movable-side electrode 7; a fixed-side bushing 80 that accommodates a fixed-side conductor 70; a fixed-side frame 75 that electrically connects the fixed-side conductor 70 and the fixed-side electrode 8; and insulating support cylinders 90 and 91 that support the movable-side frame 55, the vacuum valve 10, and the fixed-side frame 75 in the tank 20.

The vacuum valve 10 illustrated in FIG. 2 is in a interrupting state in which the movable-side electrode 7 and the fixed-side electrode 8 are not in contact with each other. The vacuum valve 10 includes: the cylindrical vacuum container 4; a first flange 1a and a second flange 1b that occlude both end portions of the vacuum container 4, the drive rod 6 that penetrates the first flange 1a, has one end portion disposed in the vacuum container 4, and moves the movable-side electrode 7 fixed to the one end portion in the vacuum container 4 to switch between a closing state in which the movable-side electrode 7 and the fixed-side electrode 8 are in contact with each other and an interrupting state in which the movable-side electrode 7 and the fixed-side electrode 8 are not in contact with each other, a fixing rod 11 penetrating the second flange 1b; the fixed-side electrode 8 installed at one end portion of the fixed rod 11; a bellows flange 9 fixed to a side surface of the drive rod 6, a bellows 3 bridged between the first flange 1a and the bellows flange 9; and a sliding member 2 fixed to the bellows flange 9 and disposed in a cylinder of the bellows 3. The bellows 3 has a concertina tube shape and has a plurality of pleats 3a. The drive rod 6 penetrates the first flange 1a and protrudes to the outside of the vacuum container 4 while penetrating an inside of the insulating support cylinder 91, and is connected to the operation device 40 outside the vacuum container 4. The movable-side electrode 7 is installed at the end portion of the drive rod 6 disposed in the vacuum container 4.

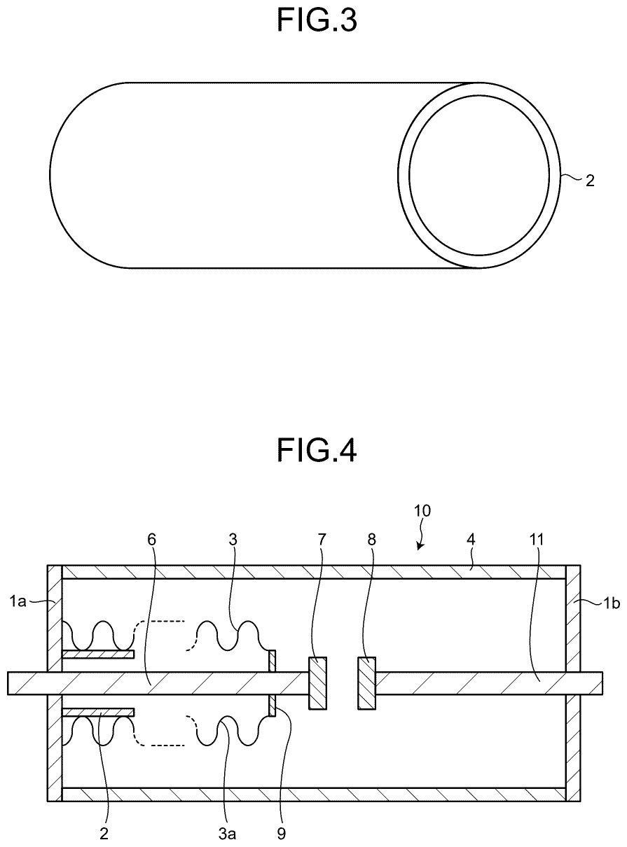

FIG. 3 is a perspective view of a sliding member of the vacuum valve according to the first embodiment. The sliding member 2 is formed containing a non-porous material such as metal. The sliding member 2 has a cylindrical shape having an outer diameter slightly larger than an inner diameter of the bellows 3. Therefore, the bellows 3 in which the sliding member 2 is inserted into the cylinder is pushed and spread, and the plurality of pleats 3a are in contact with the sliding member 2 at an inner peripheral portion of the bellows 3.

When the interrupting state illustrated in FIG. 2 is switched to the closing state in which the movable-side electrode 7 and the fixed-side electrode 8 are in contact with each other, the drive rod 6 is pushed toward the fixed-side electrode 8, and the bellows 3 is extended. When the bellows 3 is extended, the plurality of pleats 3a slide along an outer cylinder surface of the sliding member 2 in the inner peripheral portion of the bellows 3. When the bellows 3 is extended while the plurality of pleats 3a are in contact with the sliding member 2, generation of vibration in the pleats 3a in an axial direction of the bellows 3 is reduced at the time of extension, and damping of the vibration generated in the pleats 3a in the axial direction of the bellows 3 is increased.

This similarly applies to when the bellows 3 is contracted. When the bellows 3 is contracted while the plurality of pleats 3a are in contact with the sliding member 2, generation of vibration in the pleats 3a in the axial direction of the bellows 3 is reduced at the time of contraction, and damping of the vibration generated in the pleats 3a in the axial direction of the bellows 3 is increased.

The vacuum valve 10 according to the first embodiment can reduce generation of vibration itself in the pleats 3a in the axial direction of the bellows 3 when the bellows 3 is extended and contracted, and can quickly damp the vibration generated in the pleats 3a in the axial direction of the bellows 3. Therefore, the vacuum valve 10 according to the first embodiment can reduce vibration generated in the pleats 3a in the axial direction of the bellows 3 when the bellows 3 is extended and contracted, and can enhance the vibration resistance of the bellows 3 without increasing a size of the bellows 3.

### Second Embodiment

FIG. 4 is a cross-sectional view of a vacuum valve according to a second embodiment. The vacuum valve 10 according to the second embodiment is different from the vacuum valve 10 according to the first embodiment in that the sliding member 2 is fixed to the first flange la inside the vacuum container 4. In the vacuum valve 10 according to the second embodiment, a position of the sliding member 2 does not change when the bellows 3 is extended and contracted. In the vacuum valve 10 according to the second embodiment, when the bellows 3 is extended and contracted, the plurality of pleats 3a slide along an outer cylinder surface of the sliding member 2 in an inner peripheral portion of the bellows 3, whereby vibration generated in the pleats 3a of the bellows 3 in the axial direction of the bellows 3 is reduced.

Similarly to the vacuum valve 10 according to the first embodiment, the vacuum valve 10 according to the second embodiment can reduce vibration generated in the pleats 3a in the axial direction of the bellows 3 when the bellows 3 is extended and contracted, and can enhance the vibration resistance of the bellows 3 without increasing a size of the bellows 3. Furthermore, in the vacuum valve 10 according to the second embodiment, since the sliding member 2 does not move when the bellows 3 is extended and contracted, inertial force due to a mass of the sliding member 2 does not hinder the extension and contraction of the bellows 3. Therefore, the vacuum valve 10 according to the second embodiment can easily speed up the closing operation and the interrupting operation.

### Third Embodiment

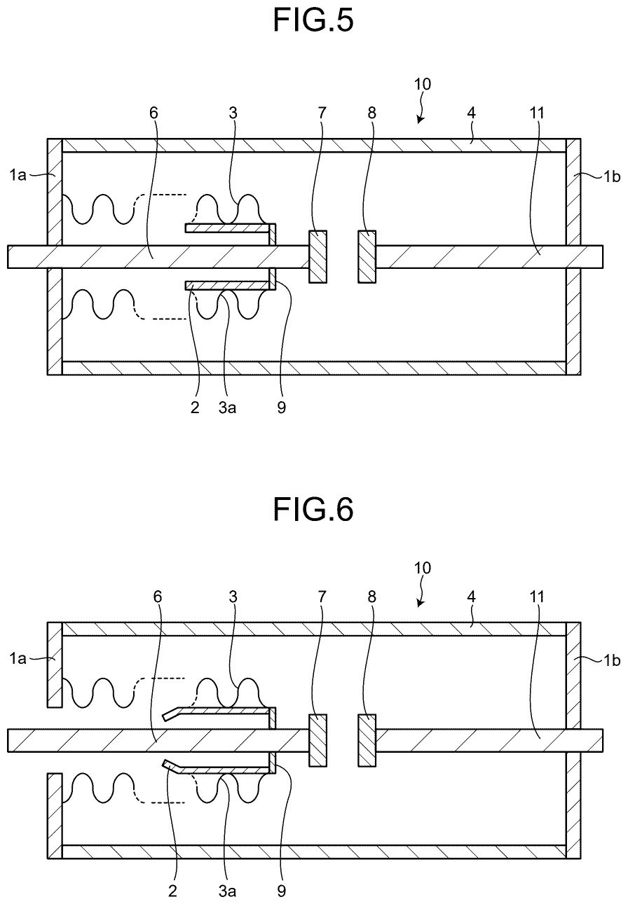

FIG. 5 is a cross-sectional view of a vacuum valve according to a third embodiment. The vacuum valve 10 according to the third embodiment is different from the vacuum valve 10 according to the first embodiment in that the sliding member 2 does not penetrate the first flange la inside the vacuum container 4. In the vacuum valve 10 according to the third embodiment when the bellows 3 is extended and contracted, the plurality of pleats 3a slide along an outer cylinder surface of the sliding member 2 in an inner peripheral portion of the bellows 3, whereby vibration generated in the pleats 3a of the bellows 3 in the axial direction of the bellows 3 is reduced. The sliding member 2 moves together with the bellows flange 9 when the bellows 3 is extended and contracted, but does not penetrate the first flange 1a, so that the sliding member 2 does not slide with the first flange 1a.

Similarly to the vacuum valve 10 according to the first embodiment, the vacuum valve 10 according to the third embodiment can reduce vibration generated in the pleats 3a in the axial direction of the bellows 3 when the bellows 3 is extended and contracted, and can enhance the vibration resistance of the bellows 3 without increasing a size of the bellows 3. Furthermore, in the vacuum valve 10 according to the third embodiment, friction does not occur between the sliding member 2 and the first flange la at the time of closing and interruption, so that the sliding member 2 is less likely to hinder the extension and contraction of the bellows 3. Therefore, the vacuum valve 10 according to the third embodiment can easily speed up the closing operation and the interrupting operation.

### Fourth Embodiment

FIG. 6 is a cross-sectional view of a vacuum valve according to a fourth embodiment. In the vacuum valve 10 according to the fourth embodiment, similarly to the vacuum valve 10 according to the third embodiment, the sliding member 2 does not penetrate the first flange 1a inside the vacuum container 4. The sliding member 2 is fixed to the bellows flange 9. In the vacuum valve 10 according to the fourth embodiment, a free end of the sliding member 2 that is not fixed has a tapered shape.

Since an outer diameter of the sliding member 2 is slightly larger than an inner diameter of the bellows 3, the sliding member 2 pushes and spread the bellows 3 and is inserted into the bellows 3 when the bellows 3 is contracted. For this reason, there is a possibility that the free end of the sliding member 2 interferes with the pleats 3a of the bellows 3 when the bellows 3 is contracted. In the vacuum valve 10 according to the fourth embodiment, since the free end of the sliding member 2 has a tapered shape, the free end of the sliding member 2 is less likely to interfere with the pleats 3a of the bellows 3 when the bellows 3 is contracted. Therefore, the vacuum valve 10 according to the fourth embodiment can enhance durability of the bellows 3 as compared with the vacuum valve 10 according to the third embodiment.

### Fifth Embodiment

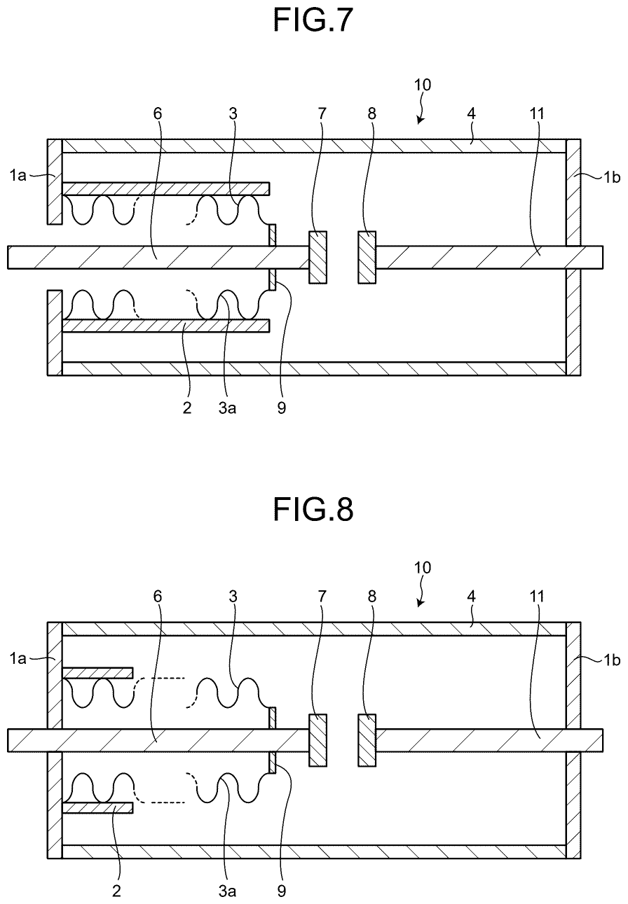

FIG. 7 is a cross-sectional view of a vacuum valve according to a fifth embodiment. The vacuum valve 10 according to the fifth embodiment is different from the Vacuum valve 10 according to the first embodiment in that the sliding member 2 is installed on an outer diameter side of the bellows 3. The sliding member 2 is fixed to the first flange 1a. An inner diameter of the sliding member 2 is slightly smaller than an outer diameter of the bellows 3. Therefore, the bellows 3 inserted into the cylinder of the sliding member 2 is compressed in a radial direction. When the bellows 3 is extended and contracted, the plurality of pleats 3a slide along an inner cylinder surface of the sliding member 2 at an outer peripheral portion of the bellows 3. When the bellows 3 is extended and contracted while the plurality of pleats 3a are in contact with the sliding member 2, generation of vibration in the pleats 3a in the axial direction of the bellows 3 is reduced at the time of extension and contraction, and damping of the vibration generated in the pleats 3a in the axial direction of the bellows 3 is increased.

In the vacuum valve 10 according to the fifth embodiment, since the sliding member 2 does not move when the bellows 3 is extended and contracted, inertial force due to a mass of the sliding member 2 does not hinder the extension and contraction of the bellows 3. Therefore, the vacuum valve 10 according to the fifth embodiment can easily speed up the closing operation and the interrupting operation.

FIG. 8 is a cross-sectional view of a vacuum valve according to a modification of the fifth embodiment. The sliding member 2 is installed only in a part of the bellows 3 near the first flange 1a. When the bellows 3 is extended and contracted, the plurality of pleats 3a do not uniformly vibrate, but some pleats 3a vibrate strongly and some pleats 3a vibrate weakly. In which part the pleats 3a vibrate strongly and in which part the pleats 3a vibrate weakly varies depending on a shape of the bellows 3 and a speed of the closing and interrupting operations. Therefore, when vibration of the pleats 3a in a part of the bellows 3 close to the first flange 1a becomes strong, vibration of the pleats 3a in the axial direction of the bellows 3 can be reduced also by installing the sliding member 2 so as to be in contact with only the part of the pleats 3a close to the first flange 1a.

### Sixth Embodiment

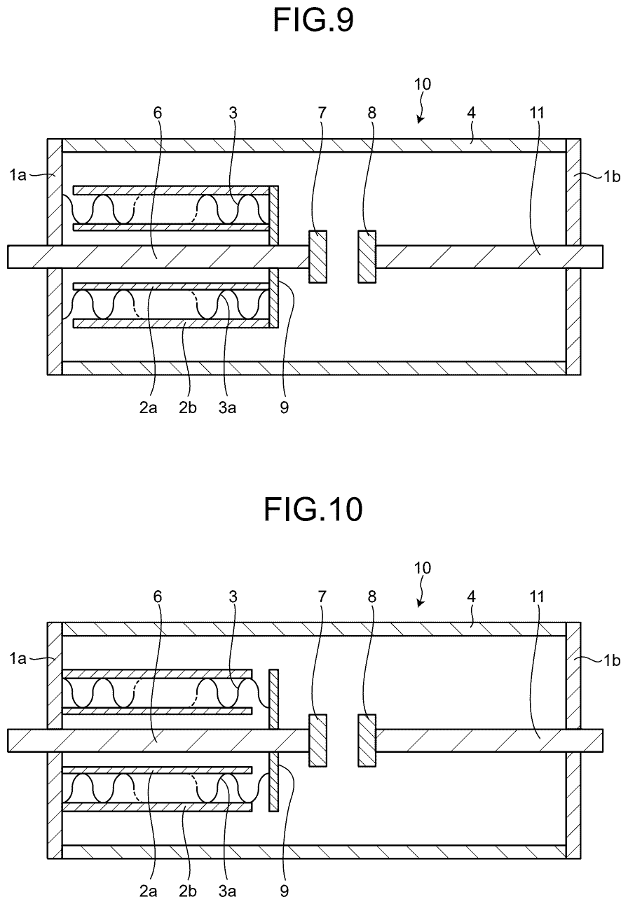

FIG. 9 is a cross-sectional view of a vacuum valve according to a sixth embodiment. The vacuum valve 10 according to the sixth embodiment is different from the vacuum valve 10 according to the first embodiment in that a sliding member 2a is installed on an inner diameter side of the bellows 3 and a sliding member 2b is installed on an outer diameter side of the bellows 3. The sliding members 2a and 2b are fixed to the bellows flange 9. An outer diameter of the sliding member 2a is slightly larger than an inner diameter of the bellows 3. Further, an inner diameter of the sliding member 2b is slightly smaller than an outer diameter of the bellows 3. Therefore, in the bellows 3, the pleats 3a are sandwiched between the sliding member 2a and the sliding member 2b.

In the vacuum valve 10 according to the sixth embodiment, when the bellows 3 is extended and contracted, the pleats 3a slide on the sliding member 2a in an inner peripheral portion of the bellows 3, and the pleats 3a slide on the sliding member 2b in the outer diameter portion of the bellows 3. Therefore, as compared with the configuration in which the sliding member 2 is installed only on one of the inner diameter side or the outer diameter side of the bellows 3, the effect of reducing vibration generated in the pleats 3a in the axial direction of the bellows 3 when the bellows 3 is extended and contracted is high.

FIG. 10 is a cross-sectional view of a vacuum valve according to a first modification of the sixth embodiment. In the vacuum valve 10 according to the first modification of the sixth embodiment, the sliding members 2a and 2b are fixed to the first flange 1a. In the vacuum valve 10 according to the first modification of the sixth embodiment, since the sliding members 2a and 2b do not move when the bellows 3 is extended and contracted, the sliding members 2a and 2b is less likely to hinder the extension and contraction of the bellows 3. For this reason, the vacuum valve 10 according to the first modification of the sixth embodiment can easily speed up the closing operation and the interrupting operation.

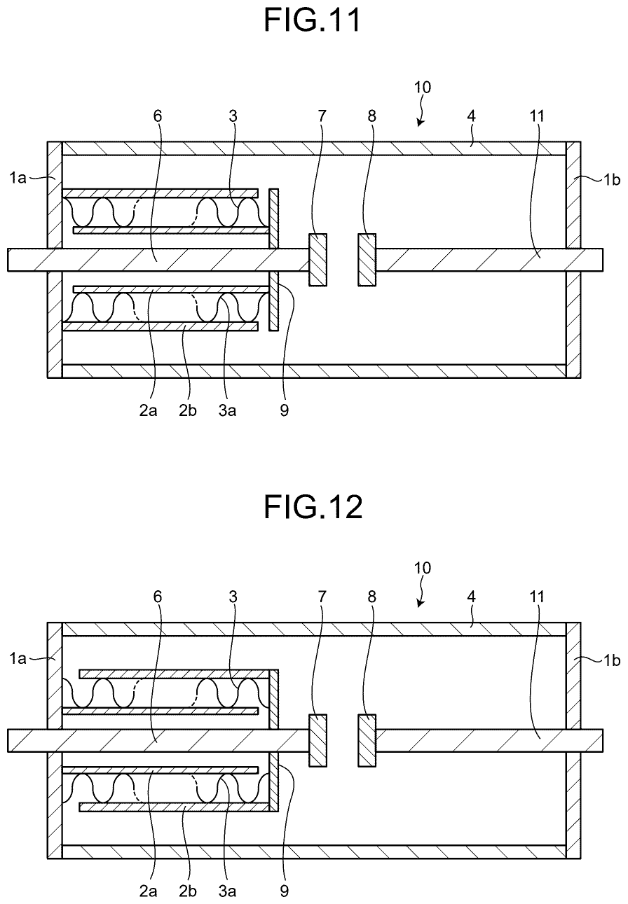

FIG. 11 is a cross-sectional view of a vacuum valve according to a second modification of the sixth embodiment. In the vacuum valve 10 according to the second modification of the sixth embodiment, the sliding member 2a is fixed to the bellows flange 9, and the sliding member 2b is fixed to the first flange la. In the vacuum valve 10 according to the second modification of the sixth embodiment, since the sliding member 2b does not move when the bellows 3 is extended and contracted, inertial force due to a mass of the sliding member 2b does not hinder the extension and contraction of the bellows 3. Therefore, the vacuum valve 10 according to the second modification of the sixth embodiment can easily speed up the closing operation and the interrupting operation.

FIG. 12 is a cross-sectional view of a vacuum valve according to a third modification of the sixth embodiment. In the vacuum valve 10 according to the third modification of the sixth embodiment, the sliding member 2a is fixed to the first flange la, and the sliding member 2b is fixed to the bellows flange 9. In the vacuum valve 10 according to the third modification of the sixth embodiment, since the sliding member 2a does not move when the bellows 3 is extended and contracted, inertial force due to a mass of the sliding member 2a does not hinder the extension and contraction of the bellows 3. Therefore, the vacuum valve 10 according to the third modification of the sixth embodiment can easily speed up the closing operation and the interrupting operation.

### Seventh Embodiment

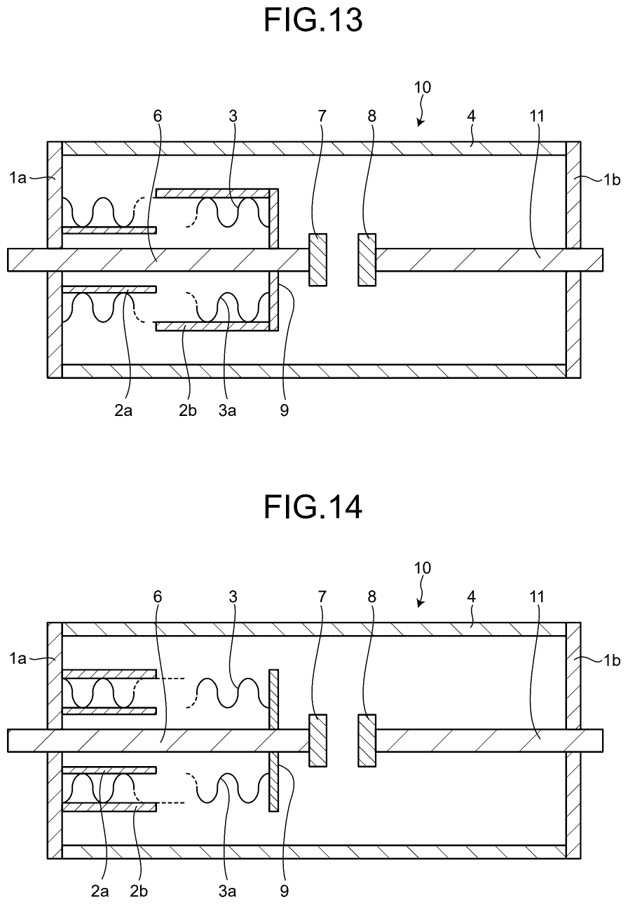

FIG. 13 is a cross-sectional view of a vacuum valve according to a seventh embodiment. In the vacuum valve 10 according to the seventh embodiment, the sliding members 2a and 2b are installed only in a part of an entire length of the bellows 3. For example, the sliding members 2a and 2b have a length of half the entire length of the bellows 3. In the vacuum valve 10 according to the seventh embodiment, the sliding member 2a is fixed to the first flange 1a, and the sliding member 2b is fixed to the bellows flange 9. Since the bellows 3 is extended and contracted while the pleats 3a are in contact with the sliding members 2a and 2b, generation of vibration in the pleats 3a in the axial direction of the bellows 3 when the bellows 3 is extended and contracted is reduced, and damping of the vibration generated in the pleats 3a in the axial direction of the bellows 3 is increased.

FIG. 14 is a cross-sectional view of a vacuum valve according to a first modification of the seventh embodiment. In the vacuum valve 10 according to the first modification of the seventh embodiment, the sliding members 2a and 2b are fixed to the first flange 1a.

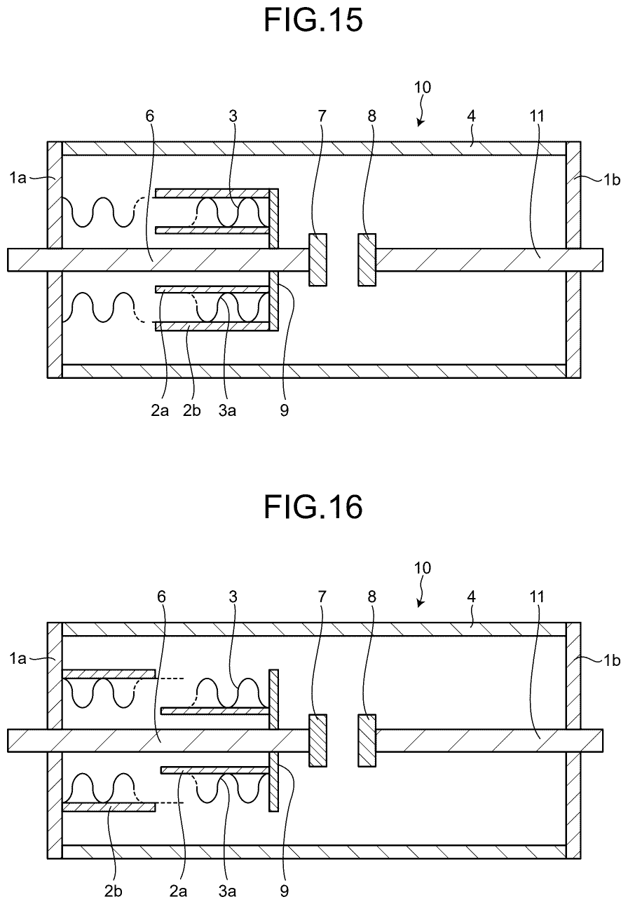

FIG. 15 is a cross-sectional view of a vacuum valve according to a second modification of the seventh embodiment. In the vacuum valve 10 according to the second modification of the seventh embodiment, the sliding members 2a and 2b are fixed to the bellows flange 9.

FIG. 16 is a cross-sectional view of a vacuum valve according to a third modification of the seventh embodiment. In the vacuum valve 10 according to the third modification of the seventh embodiment, the sliding member 2a is fixed to the bellows flange 9, and the sliding member 2b is fixed to the first flange 1a.

When the bellows 3 is extended and contracted, the plurality of pleats 3a do not uniformly vibrate, but some pleats 3a vibrate strongly and some pleats 3a vibrate weakly. In which part the pleats 3a vibrate strongly and in which part the pleats 3a vibrate weakly in the bellows 3 varies depending on a shape of the bellows 3 and a speed of the closing and interrupting operations. Therefore, it is possible to efficiently reduce vibration of the pleats 3a in the axial direction of the bellows 3 by analyzing, in advance, in which part of the bellows 3 the pleats 3a strongly vibrate through simulation or experiment and disposing the sliding members 2a and 2b in the part where the vibration of the pleats 3a becomes strong. In a case of fixing at least one of the sliding members 2a and 2b to the bellows flange 9, since the sliding members 2a and 2b are shorter than the bellows 3, inertial force due to a mass of the sliding members 2a and 2b fixed to the bellows flange 9 is less likely to hinder the extension and contraction of the bellows 3.

### Eighth Embodiment

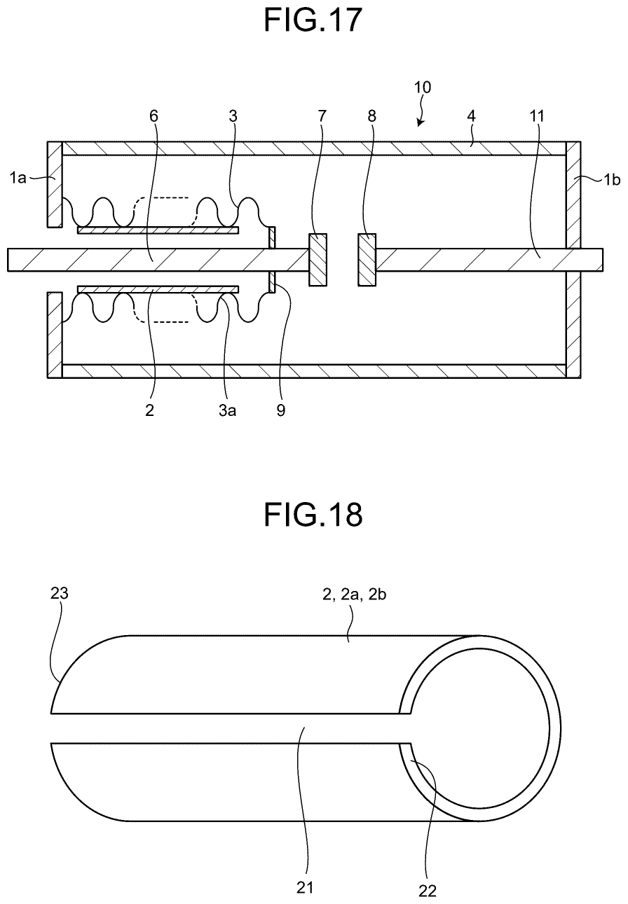

FIG. 17 is a cross-sectional view of a vacuum valve according to an eighth embodiment. The vacuum valve 10 according to the eighth embodiment is inserted into the bellows 3 without fixing of the sliding member 2. When the bellows 3 is extended, the plurality of pleats 3a slide along an outer cylinder surface of the sliding member 2 in an inner peripheral portion of the bellows 3. When the bellows 3 is extended while the plurality of pleats 3a are in contact with the sliding member 2, generation of vibration in the pleats 3a in an axial direction of the bellows 3 is reduced at the time of extension, and damping of the vibration generated in the pleats 3a in the axial direction of the bellows 3 is increased. Since the sliding member 2 can move inside the bellows 3 when the bellows 3 is extended and contracted, the sliding member 2 is less likely to hinder the extension and contraction of the bellows 3.

In the first to eighth embodiments described above, the sliding members 2, 2a, and 2b have a cylindrical shape, but the sliding members 2, 2a, and 2b can be modified into shapes other than the cylindrical shape.

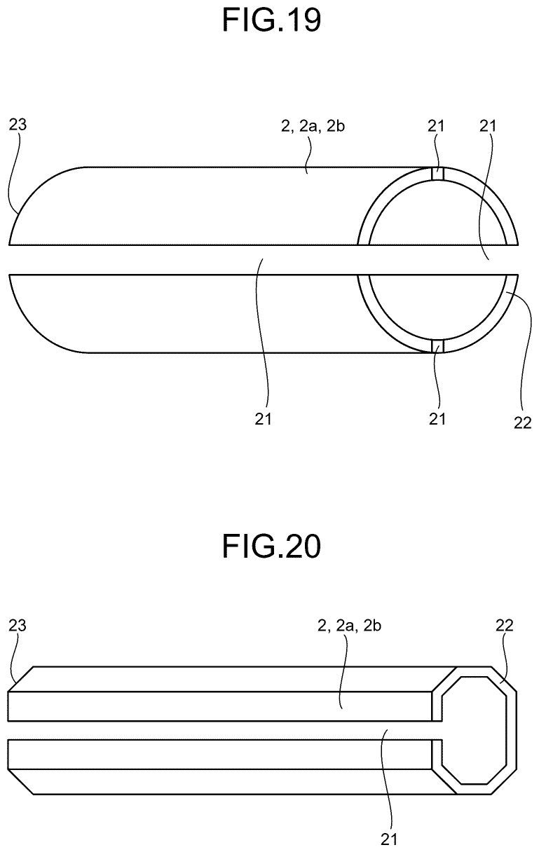

FIG. 18 is a perspective view illustrating a first modification of the sliding member of the vacuum valve according to the first to eighth embodiments. The sliding members 2, 2a, and 2b according to the first modification are provided with one slit 21 extending from one end 22 to another end 23 in the axial direction. FIG. 19 is a perspective view illustrating a second modification of the sliding member of the vacuum valve according to the first to eighth embodiments. The sliding members 2, 2a, and 2b according to the second modification are provided with four slits 21 extending from the one end 22 and reaching the another end 23 in the axial direction, and the sliding members 2, 2a, and 2b are divided into four. In the sliding members 2, 2a, and 2b according to the first modification and the second modification, the slit 21 extending from the one end 22 and reaching the another end 23 in the axial direction is provided in the sliding members 2, 2a, and 2b. Therefore, the drive rod 6 can be installed inside the sliding members 2, 2a, and 2b through the slit 21 at a time of installing the sliding members 2, 2a, and 2b. That is, since the drive rod 6 can be installed inside the sliding members 2, 2a, and 2b without the drive rod 6 passing through the sliding members 2, 2a, and 2b, the vacuum valve 10 can be easily assembled.

FIG. 20 is a perspective view illustrating a third modification of the sliding member of the vacuum valve according to the first to eighth embodiments. The sliding members 2, 2a, and 2b according to the third modification have a polygonal tubular shape, and one slit 21 extending from the one end 22 and reaching the another end 23 in the axial direction is provided. The sliding members 2, 2a, and 2b illustrated in FIG. 20 have an octagonal tubular shape, but may have a polygonal tubular shape other than the octagonal shape. In the sliding members 2, 2a, and 2b according to the third modification, since tube surfaces are formed by a combination of flat surfaces, it is easy to manufacture the sliding members 2, 2a, and 2b.

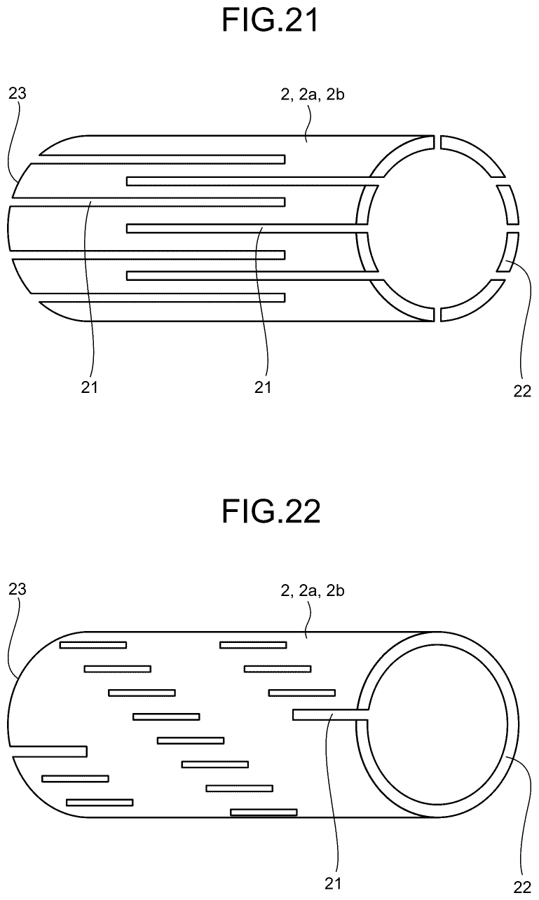

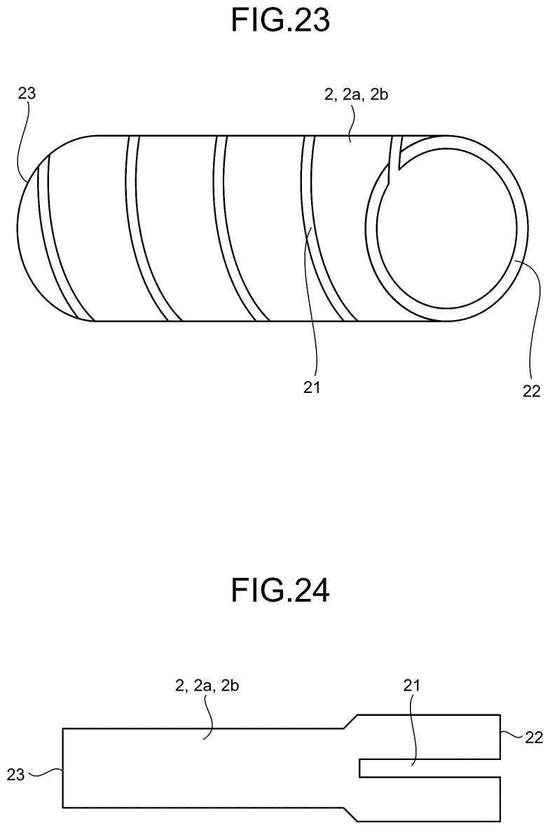

FIG. 21 is a perspective view illustrating a fourth modification of the sliding member of the vacuum valve according to any one of the first to eighth embodiments. In the sliding members 2, 2a, and 2b according to the fourth modification, the slit 21 cut from the one end 22 in the axial direction and not reaching the another end 23 and the slit 21 cut from the another end 23 in the axial direction and not reaching the one end 22 are alternately provided in a circumferential direction. FIG. 22 is a perspective view illustrating a fifth modification of the sliding member of the vacuum valve according to the first to eighth embodiments. The sliding members 2, 2a, and 2b according to the fifth modification are provided with a plurality of slits 21 extending in the axial direction and shorter than an entire length of the sliding members 2, 2a, and 2b, and the plurality of slits 21 are spirally disposed while changing an axial position and a circumferential position. FIG. 23 is a perspective view illustrating a sixth modification of the sliding member of the vacuum valve according to the first to eighth embodiments. In the sliding members 2, 2a, and 2b according to the sixth modification, a spiral slit 21 is provided from the one end 22 to the another end 23 in the axial direction.

When the sliding members 2, 2a, and 2b according to the fourth modification, the fifth modification, and the sixth modification are disposed on an outer diameter side or an inner diameter side of the bellows 3, sizes of the diameters thereof change in accordance with the bellows 3. When an entire length of the sliding member 2 is shorter than an entire length of the bellows 3, the bellows 3 has a portion to be inserted into and removed from the sliding members 2 and 2b installed on the outer diameter side when the bellows 3 is extended and contracted, or a portion which the sliding members 2 and 2a installed on the inner diameter side is inserted into and removed from when the bellows 3 is extended and contracted. Since the inner diameters of the sliding members 2 and 2b installed on the outer diameter side of the bellows 3 are smaller than the outer diameter of the bellows 3, and the outer diameters of the sliding members 2 and 2a installed on the inner diameter side of the bellows 3 are larger than the inner diameter of the bellows 3, a load associated with a change in the diameter of the bellows 3 is applied to the pleats 3a of the bellows 3 when the bellows 3 is extended and contracted. Since the sliding members 2, 2a, and 2b according to the fourth modification, the fifth modification, and the sixth modification can change the diameter, it is possible to reduce a load on the pleats 3a of the bellows 3 when the bellows 3 is inserted into and removed from the sliding members 2 or 2b or when the sliding members 2 or 2a is inserted into and removed from the bellows 3, enhancing durability of the bellows 3.

FIG. 24 is a side view illustrating a seventh modification of the sliding member of the vacuum valve according to the first to eighth embodiments. The sliding members 2, 2a, and 2b according to the seventh modification are provided with the slit 21 cut from the one end 22 in the axial direction and not reaching the another end 23, and a portion provided with the slit 21 has an enlarged diameter of the sliding members 2, 2a, and 2b.

In the sliding members 2, 2a, and 2b according to the seventh modification, since the diameter of the portion where the slit 21 is provided is enlarged, when the sliding members 2, 2a, and 2b are installed on an inner diameter side of the bellows 3, only the portion where the slit 21 is provided and the diameter is enlarged comes into contact with the pleats 3a of the bellows 3. In the sliding members 2, 2a, and 2b according to the seventh modification, since the portion in which the slit 21 is provided and the diameter is enlarged comes into contact with the pleats 3a of the bellows 3, the sliding members 2, 2a, and 2b are less likely to inhibit the extension and contraction of the bellows 3.

The configurations illustrated in the above embodiments illustrate one example of the contents and can be combined with another known technique, and it is also possible to omit and change a part of the configuration without departing from the gist.

### REFERENCE SIGNS LIST

1a first flange, 1b second flange; 2, 2a, 2b sliding member; 3 bellows, 3a pleat; 4 vacuum container; 6 drive rod; 7 movable-side electrode, 8 fixed-side electrode, 9 bellows flange; 10 vacuum valve; 11 fixing rod; 20 tank, 21 slit, 22 one end; 23 another end; 30 stand, 40 operation device; 50 movable-side conductor; 55 movable-side frame; 60 movable-side bushing; 70 fixed-side conductor; 75 fixed-side frame; 80 fixed-side bushing; 90, 91 insulating support cylinder, 100 vacuum circuit breaker.

1. (canceled)

2. (canceled)

3. A vacuum valve comprising:
a first electrode;
a second electrode;
a vacuum container having a cylindrical shape and accommodating the first electrode and the second electrode;
a first flange and a second flange to occlude both end portions of the vacuum container;
a drive rod to move the first electrode fixed to one end portion of the drive rod in the vacuum container to switch between a closing state and an interrupting state, the drive rod penetrating the first flange and having the one end portion disposed in the vacuum container, the closing state being a state in which the first electrode and the second electrode are in contact with each other, the interrupting state being a state in which the first electrode and the second electrode are not in contact with each other;
a bellows flange fixed to a side surface of the drive rod;
a bellows to be extended and contracted when the drive rod switches between the closing state and the interrupting state, the bellows having a concertina tube shape with a plurality of pleats and being bridged between the bellows flange and the first flange; and
a sliding member formed containing a non-porous material, installed on at least one of an inner diameter side and an outer diameter side of the bellows, and being in contact with a plurality of the pleats, wherein one end portion of the sliding member in an axial direction is fixed to the bellows flange.

4. The vacuum valve according to claim 3, wherein
the sliding member is installed on an inner diameter side of the bellows, and
the sliding member penetrates the first flange.

5. A vacuum valve comprising:
a first electrode;
a second electrode;
a vacuum container having a cylindrical shape and accommodating the first electrode and the second electrode;
a first flange and a second flange to occlude both end portions of the vacuum container;
a drive rod to move the first electrode fixed to one end portion of the drive rod in the vacuum container to switch between a closing state and an interrupting state, the drive rod penetrating the first flange and having the one end portion disposed in the vacuum container, the closing state being a state in which the first electrode and the second electrode are in contact with each other, the interrupting state being a state in which the first electrode and the second electrode are not in contact with each other;
a bellows flange fixed to a side surface of the drive rod;
a bellows to be extended and contracted when the drive rod switches between the closing state and the interrupting state, the bellows having a concertina tube shape with a plurality of pleats and being bridged between the bellows flange and the first flange; and
a sliding member formed containing a non-porous material, installed on at least one of an inner diameter side and an outer diameter side of the bellows, and being in contact with a plurality of the pleats, wherein
the sliding member is installed on both an inner diameter side and an outer diameter side of the bellows, and
an end portion in an axial direction of the sliding member installed on the inner diameter side of the bellows and the sliding member installed on the outer diameter side of the bellows are fixed to the bellows flange or the first flange.

6. The vacuum valve according to claim 3, wherein another end portion of the sliding member has a tapered shape in which a diameter decreases as a distance from the one end portion increases, the another end portion being an end portion on a side opposite to the one end portion.

7. A vacuum valve comprising:
a first electrode;
a second electrode;
a vacuum container having a cylindrical shape and accommodating the first electrode and the second electrode;
a first flange and a second flange to occlude both end portions of the vacuum container;
a drive rod to move the first electrode fixed to one end portion of the drive rod in the vacuum container to switch between a closing state and an interrupting state, the drive rod penetrating the first flange and having the one end portion disposed in the vacuum container, the closing state being a state in which the first electrode and the second electrode are in contact with each other, the interrupting state being a state in which the first electrode and the second electrode are not in contact with each other;
a bellows flange fixed to a side surface of the drive rod;
a bellows to be extended and contracted when the drive rod switches between the closing state and the interrupting state, the bellows having a concertina tube shape with a plurality of pleats and being bridged between the bellows flange and the first flange; and
a sliding member formed containing a non-porous material, installed on an inner diameter side of the bellows, and being in contact with a plurality of the pleats, wherein the sliding member is inserted into the bellows without being fixed to any part of the bellows, the first flange, and the bellows flange.

8. The vacuum valve according to claim 3, wherein the sliding member has a cylindrical shape or a polygonal tubular shape.

9. The vacuum valve according to claim 8, wherein the sliding member is divided into a plurality of parts in a circumferential direction by a slit extending from one end and reaching another end in an axial direction.

10. The vacuum valve according to claim 8, wherein, in the sliding member, a slit cut from one end in an axial direction and not reaching another end and a slit cut from the another end in the axial direction and not reaching the one end are alternately provided in a circumferential direction.

11. The vacuum valve according to claim 8, wherein the sliding member is provided with a plurality of slits that extend in an axial direction and are shorter than an entire length of the sliding member, and a plurality of the slits are spirally disposed while changing an axial position and a circumferential position.

12. The vacuum valve according to claim 8, wherein the sliding member is provided with a spiral slit extending from one end and reaching another end in an axial direction.

13. A vacuum circuit breaker comprising the vacuum valve according to claim 3.

14. The vacuum valve according to claim 5, wherein another end portion of the sliding member has a tapered shape in which a diameter decreases as a distance from the one end portion increases, the another end portion being an end portion on a side opposite to the one end portion.

15. The vacuum valve according to claim 5, wherein the sliding member has a cylindrical shape or a polygonal tubular shape.

16. The vacuum valve according to claim 7, wherein the sliding member has a cylindrical shape or a polygonal tubular shape.

17. The vacuum valve according to claim 15, wherein the sliding member is divided into a plurality of parts in a circumferential direction by a slit extending from one end and reaching another end in an axial direction.

18. The vacuum valve according to claim 16, wherein the sliding member is divided into a plurality of parts in a circumferential direction by a slit extending from one end and reaching another end in an axial direction.

19. The vacuum valve according to claim 15, wherein, in the sliding member, a slit cut from one end in an axial direction and not reaching another end and a slit cut from the another end in the axial direction and not reaching the one end are alternately provided in a circumferential direction.

20. The vacuum valve according to claim 16, wherein, in the sliding member, a slit cut from one end in an axial direction and not reaching another end and a slit cut from the another end in the axial direction and not reaching the one end are alternately provided in a circumferential direction.

21. A vacuum circuit breaker comprising the vacuum valve according to claim 5.

22. A vacuum circuit breaker comprising the vacuum valve according to claim 7.
